(19) United States
(12) Patent Application Publication
(10) Pub. No.: US 2026/0106802 A1
(43) Pub. Date: Apr. 16, 2026

(54) PREDICTION OF ANOMALY CASCADES IN INTERCONNECTED SYSTEMS

(71) Applicants: International Business Machines Corporation, Armonk, NY (US); Rensselaer Polytechnic Institute, Troy, NY (US)

(72) Inventors: Kyong Min Yeo, Scarsdale, NY (US); Wesley M. Gifford, Ridgefield, CT (US); Anmol Dwivedi, Gurugram (IN); Shiuli Subhra Ghosh, Kolkata (IN); Ali Tajer, Clifton Park, NY (US)

(21) Appl. No.: 18/915,503

(22) Filed: Oct. 15, 2024

(51) Int. Cl. H04L 41/147; H04L 41/12; H04L 41/14

(52) U.S. Cl. CPC H04L 41/147; H04L 41/12; H04L 41/145

(57) ABSTRACT

Systems and techniques that facilitate prediction of anomaly cascades in interconnected systems are provided. For example, one or more embodiments described herein can comprise a system, which can comprise a memory that can store computer executable components. The system can also comprise a processor, operably coupled to the memory that can execute the computer executable components stored in memory. The computer executable components can comprise a prediction machine learning model that predicts propagation of anomaly cascades through an interconnected system.

### BACKGROUND

The subject disclosure relates to anomaly cascades, and more specifically, to prediction of anomaly cascades in interconnected systems in accordance with one or more embodiments described herein.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that facilitate prediction of anomaly cascades and propagation in interconnected systems are provided.

According to an embodiment, a system can comprise a processor that executes computer executable components stored in memory. The computer executable components can comprise a prediction machine learning model that predicts propagation of anomaly cascades through an interconnected system, wherein the predicting comprises extracting a data matrix from a causal graph, wherein the causal graph represents an interconnected system; and generating a data set comprising at least one of historic data or a simulation data set of the interconnected system.

According to another embodiment, a computer-implemented method can comprise predicting, by a device operatively coupled to a processor, propagation of anomaly cascades through an interconnected system, wherein the predicting comprises: extracting, by the device, a data matrix from a causal graph, wherein the causal graph represents an interconnected system; and generating, by the device, a data set comprising at least one of historic data or a simulation data set of the interconnected system.

According to another embodiment, a computer program product can comprise a computer readable storage medium having program instructions embodied therewith, the program instructions executable by a processor to cause the processor to predict, by the processor, propagation of anomaly cascades through an interconnected system, wherein the predicting comprises: extracting, by the processor, a data matrix from a causal graph, wherein the causal graph represents an interconnected system; and generating, by the processor, a data set comprising at least one of historic data or a simulation data set of the interconnected system.

### DESCRIPTION OF THE DRAWINGS

FIG. 1 illustrate a block diagram of an example, non-limiting, system that can facilitate prediction of anomaly cascades in accordance with one or more embodiments described herein.

FIG. 2 illustrates an example of a causal structural graph in accordance with one or more embodiments described herein.

FIG. 3 illustrates a comparison of a topological model of an interconnected system and a causal graph of the interconnected system in accordance with one or more embodiments described herein.

FIG. 4 illustrates a flow diagram of an example, non-limiting, training method for a prediction machine learning model in accordance with one or more embodiments described herein.

FIG. 5 illustrates a flow diagram of real-time cascade propagation prediction in accordance with one or more embodiments described herein.

FIGS. 6-9 illustrate algorithms utilized by a prediction machine learning model as part of a process for the prediction of anomaly cascades in accordance with one or more embodiments described herein.

FIG. 10 illustrates a graph comparing the accuracy of a prediction machine learning model (e.g., C-path algorithm) as described herein to an influence graph (e.g., IG) approach in accordance with one or more embodiments described herein.

FIG. 11 illustrates a graph comparing the performance of a prediction machine learning model (e.g., C-path algorithm) as described herein to an influence graph (e.g., IG) approach at predicting high-cost anomaly propagations.

FIG. 12 illustrates a flow diagram of an example, non-limiting, computer implemented method that facilitates predictions of propagations of anomalies within interconnected systems in accordance with one or more embodiments described herein.

FIG. 13 illustrates an example, a non-limiting environment for the execution of at least some of the computer code in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

As referenced herein, an “entity” can comprise a client, a user, a computing device, a software application, an agent, a machine learning (ML) model, an artificial intelligence (AI) model, and/or another entity.

Machine learning simulation of the dynamics of complex networks has direct relevance to many practical problems related to the operation of said complex networks. When anomalies occur within complex networks, they propagate throughout the network, causing additional anomalies and possible failure points. Accordingly, it is critical to identify and predict such propagations of anomalies to accurately prevent large scale disruptions. However, existing approaches are not able to predict non-local propagation of the anomalies, thereby limiting usefulness. For example, scenario-based simulations lack the versatility to represent all possible cascading failure scenarios. Furthermore, as it is not possible to manually create all conceivable scenarios, these methods tend to focus on the more probable scenarios, potentially overlooking low-probability yet high risk situations. Topology-guided approaches implicitly assume that anomalies and failures follow the paths defined by interconnected components, but often fail to predict non-local cascades of anomalies. Furthermore, topological models are often unable to provide real-time prediction of anomaly cascades, thereby limiting their usefulness.

In view of the problems discussed above, the present disclosure can be implemented to produce a solution to one or more of these problems by predicting, by a device operatively couple to a processor, propagation of anomaly cascades through an interconnected system, wherein the predicting comprises extracting a data matrix from a causal graph, wherein the causal graph represents an interconnected system; and generating, by the device, a data set comprising at least one of historic data or a simulation data set of the interconnected system. The predicting can further comprise generating a causal structural model based on the generated data set, simulating a cascading of anomalies based on the causal structural model and determining non-local behavior of the interconnected system, based on the cascading of anomalies.

For example, a graphical model can be constructed in which nodes represent the network components and the edges collectively encode the complex cause-effect relationships among the network components. This addresses the questions of what happens if the behavior of one component is varied and the behavior of all others are fixed. Accordingly, the causal structural model depicts the cause-effect relationships among the nodes as directed edges and the extended cause-effect relationships are specified by structural equation models. Such a latent causal graph signifies how anomalies propagate on paths that do not conform to the system's topology and eventually provide higher predictive power for specifying the consequences of an anomaly. This causal graph can then be used to train a prediction machine learning model to learn a data matrix describing how status changes within one component of the interconnected system impact other components within the interconnected system. A simulation or historical data of the interconnected system can then be utilized to identify how significant specific cascades of anomalies are to the system. Using this information, the prediction machine learning model can make real-time predictions both of the cascades of anomalies most likely to occur, as well as the possible cascades of anomalies most likely to cause significant stress to the interconnected system.

This framework is data-driven and has the following three features that distinguish it from existing approaches. First, it is computationally efficiency and does not face the prohibitive complexity of existing approaches, such as full simulation-based approaches, enabling predictions in real-time. Second, it accounts for non-local propagation of cascades, which topology-guided approaches do not account for. Third it leverages the data structure embedded in a latent space and uses that to uncover the cause-effect relationships, exceeding beyond the existing approaches that focus only on statistical relationships. The proposed framework learns cause-effect relationships from observed historical data to go beyond finding statistical correlation and uncover causation. The anomalies within a cascade are formalized by incorporating sequential interventions to circumvent the computational complexity of recursively re-learning the network dynamics at each cascading stage. Subsequently the causal path analysis is leveraged to address the challenge of local and non-local anomaly propagation in the network for predicting anomalies.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

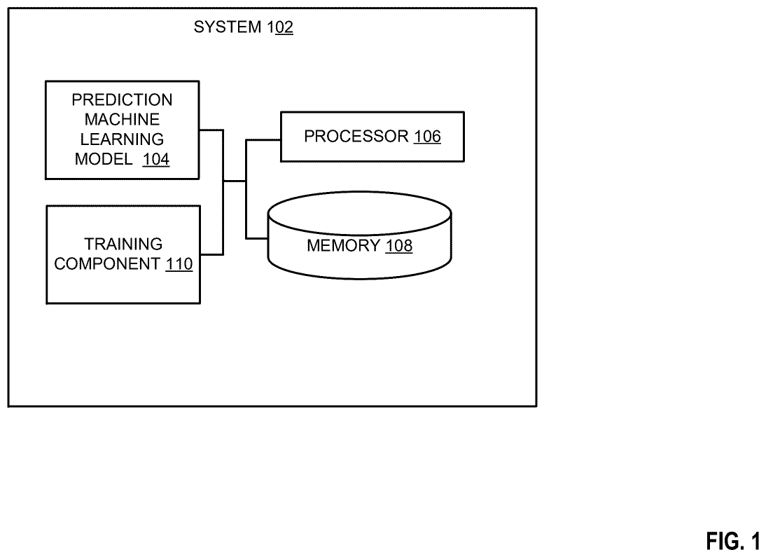

FIG. 1 illustrates a block diagram of an example, non-limiting cascade prediction system 102 that can facilitate propagation of anomaly cascades through an interconnected system Aspects of systems (e.g., system 102 and the like), apparatuses or processes in various embodiments of the present invention can constitute one or more machine-executable components embodied within one or more machines (e.g., embodied in one or more computer readable mediums (or media) associated with one or more machines). Such components, when executed by the one or more machines, e.g., computers, computing devices, virtual machines, etc. can cause the machines to perform the operations described. System 102 can comprise prediction machine learning model 104, training component 110, processor 106 and memory 108.

In various embodiments, system 102 can comprise a processor 106 (e.g., a computer processing unit, microprocessor) and a computer-readable memory 108 that is operably connected to the processor 106. The memory 108 can store computer-executable instructions which, upon execution by the processor, can cause the processor 106 and/or other components of the system 102 (e.g., prediction machine learning model 104, training component 110) to perform one or more acts. In various embodiments, memory 108 can store computer-executable components (e.g., prediction machine learning model 104, training component 110) The processor 106 can execute the computer-executable components.

In one or more embodiments, prediction machine learning model 104 can predict propagation of anomaly cascades through an interconnected system, wherein the predicting comprises extracting a data matrix from a causal graph, wherein the causal graph represents an interconnected system, generating a data set comprising at least one of historical data or a simulation data set of the interconnected system. In one or more embodiments, the predicting can further comprise generating a causal structural model based on the generated data set, simulating a cascading of anomalies based on the causal structural model and determining non-local behavior of the interconnected system, based on the cascading of anomalies. To facilitate these predictions, training component 110 can train prediction machine learning model 104 to learn non-local interactions of the interconnected system through a latent causal graph, wherein the latent causal graph comprises observational multi-variate time series data from the interconnected system. While the following example describes the interconnected system as comprising an electrical power grid, it should be appreciated that the systems, methods and techniques described herein can be applies to predict propagation of anomalies in any form of interconnect system, such as but not limited to, communications networks, computer networks, traffic networks, supply chains, or other interconnected systems.

In an example, consider a power transmission network consisting of N transmission lines and L loads. The absolute active power flow in line i is denoted as i∈[N]≙{1, . . . , N} at the discrete time instant t∈ [symbol] by Pᵢ[t]. Accordingly,

$$P [ t ] {=}^{Δ} {[ {P}_{1} [ t ] , … , {P}_{N} [ t ] ]}^{T} . \qquad ( 1 )$$

Each line i∈[N] is subject to a maximum power flow constraint denoted as

$${P}_{i}^{max} .$$

Various internal factors, such as system instabilities, or external factors, such as weather conditions can potentially contribute to anomalous behavior in transmission lines. To model the presence and extent of potential anomalies in line i∈[N], Sᵢ[t] is defined as an anomaly qualification index that captures the deviation in the power flow in line i at time t from the power flow at time t−1 given by

$${S}_{i} [ t ] {=}^{Δ} \frac{{P}_{i} [ t ] − {P}_{i} [ t − 1 ]}{{P}_{i}^{max}} = \frac{Δ {P}_{i} [ t ]}{{P}_{i}^{max}} . \qquad ( 2 )$$

In order to account for the differences in maximum capacities across transmission lines, the flow deviations ΔPᵢ[t] are normalized by their respective maximum capacities

$${P}_{i}^{max} .$$

Accordingly, the anomaly vector at time t associated with all lines is denoted by S[t]≙[S₁[t], . . . , S_{N}[t]]^{T}. To effectively represent the severity of an anomaly, Sᵢ[t] can be discretized into T distinct levels, thereby assigning different anomaly states \tilde{S}ᵢ[t]∈S≙{s₁, . . . , s_{T}} to represent varying degrees of anomalies. For instance, when concerned only about distinguishing line outages, set T=2, based on which \tilde{S}ᵢ[t]=s₁ indicates that line i is healthy, while \tilde{S}ᵢ[t]=s₂ signifies that the line is in an outage. Similarly, when anomalies are specified as significant deviations of power flow from the expected ranges, the set {s₁, . . . , s_{T}} can be specified to represent a desired level of granularity in these deviations. Consequently, the discrete anomaly vector at time t is defined by \tilde{S}[t]≙[\tilde{S}₁[t], . . . , \tilde{S}_{N}[t]]. The focus is on persistent anomalies, that is once a line is anomalous, it remains in the same state until a remedial action is exerted. Additionally, the set [symbol] ₜ is defined to specify the set of transmission lines that become anomalous at time t by

$${𝒰}_{t} {=}^{Δ} \{ i ∈ [ N ] : {\tilde{S}}_{i} [ t ] \neq {s}_{1} , {\tilde{S}}_{i} [ t − 1 ] = {s}_{1} \} . \qquad ( 3 )$$

When an emerging anomaly in the interconnected system is severe enough, it can stress the system, e.g., a line outage in a transmission line can lead to overloads. These can lead to additional anomalous events, causing a cascade or sequence of anomalies. To formalize the model for cascading anomalies and their associated risk, system 102 can start by specifying an anomaly-free system that precedes a cascade and denote the associated power flow and anomaly state variables before an anomaly starts emerging by P[0] and S[0] respectively. The number of stages over which the sequence of anomalies materializes is denoted by M. The set of anomalous lines that are added to the cascade in stage m∈[M] is denoted by [symbol] ₘ≤[N]. Collectively, the sequence of anomalous lines throughout the M stages is denoted by

$$𝒱 {=}^{Δ} 〈 {𝒰}_{1} , … , {𝒰}_{M} 〉 . \qquad ( 4 )$$

Without loss of generality, it can be assumed that at each stage only one transmission line can be anomalous, e.g., | [symbol] ₘ|=1. To capture the stress imposed on the system by an anomaly sequence, the cost incurred due to cascade [symbol] is denoted as

$$cost ( 𝒱 ) {=}^{Δ} {\sum }_{m = 1}^{M} {\sum }_{i = 1}^{N} \vert {S}_{i} [ m ] \vert . \qquad ( 5 )$$

In transmission networks, cascading anomalies arise from complex, latent interactions among transmission lines, rendering the propagation unpredictable. While certain cascades may occur with high frequency, others, particularly those resulting in significant disruption, may transpire only a few times. Thus, the real-time prediction and identification of these anomalies are crucial to maintaining system stability and reliability. Accordingly, prediction machine learning model 104 can have two objectives. First, pertains to the real-time prediction of anomalies that are most likely to occur in the subsequent stage, based on observation in the past stages. Second, pertains to the real-time prediction of the possible sequence of anomalies that are most costly.

Motivated by forming fast situational awareness about the consequences of emerging anomalies at stage m∈[M] based on the past states of an anomalous sequence [symbol] , captures via P̅ₘ and S̅ₘ, defined by

$${\overline{P}}_{m} {=}^{Δ} \{ P [ i ] : i ∈ [ m ] \} , and {\overline{S}}_{m} {=}^{Δ} \{ S [ i ] : i ∈ [ m ] \} , \qquad ( 6 )$$

the objective is to identify the transmission line that is most likely to anomalous in stage m+1. Therefor the problem of likely anomalies is formalized as

$${𝒫}_{i} : {\hat{𝒰}}_{m + 1} {=}^{Δ} \begin{matrix}arg max \\ 𝒰 ⊆ [ N ] ∖ 〈 {𝒰}_{1} , … , {𝒰}_{m} 〉 ; \vert 𝒰 \vert \leq k\end{matrix} ℙ ( 𝒰 \vert {\overline{P}}_{m} , {\overline{S}}_{m} ) , \qquad ( 7 )$$

where [symbol] ₘ₊₁ represents the predicted set of potential anomalies, limited to k lines/components, given the past network states.

In regard to costly anomalies, anomalies often emerge gradually and can vary significantly in their impact. To model costly sequences of anomalies, [symbol] can be defined as the set of all dependent anomalous sequences occurring over M stages and the objective is to identify d such anomalous sequences that deemed high cost, formalized as

$${𝒫}_{2} : \{ {𝒱}_{1}^{*} , … , {𝒱}_{d}^{*} \} {=}^{Δ} {arg max}_{\{ {𝒱}_{1}^{*} , … , {𝒱}_{d}^{*} \} : {𝒱}_{i} ∈ 𝒵} {\sum }_{i = 1}^{d} cost ( {𝒱}_{i} ) . \qquad ( 8 )$$

Without loss of generality, these d sequences are specified such that their associated costs appear in decreasing order, e.g.,

$$cost ( {𝒱}_{1}^{*} ) > cost ( {𝒱}_{2}^{*} ) > … > cost ( {𝒱}_{d}^{*} ) .$$

Solving [symbol] ₂ can be computationally expensive as the complexity of the search space [symbol] grows exponentially with the number of line N and the cascade horizon M, rendering solving [symbol] ₂ to be computationally prohibitive even for moderate values of N and M.

To assess the accuracy of the predictions derived from solving [symbol] ₁ and [symbol] ₂, the following accuracy metrics are provided. Corresponding to a prediction [symbol] ₘ provide by [symbol] ₁ and its associate ground truth [symbol] ₘ, a precision metric is defined that quantifies the fraction of correct predictions associates with each of the M−1 stages within a cascading sequence. Specifically, for any cascade [symbol] , define

$$precision ( 𝒱 ) {=}^{Δ} \frac{1}{M - 1} \cdot {\sum }_{m = 2}^{M} 𝟙 \{ {𝒰}_{m} ∈ {\hat{𝒰}}_{m} \} , \qquad ( 9 )$$

wherein [symbol] {·} denotes the indicator function, which takes a value of 1 when the ground truth [symbol] ₘ lies in the predicted set [symbol] ₘ. Accordingly, a higher precision value indicates a higher accuracy.

Additionally, a regret metric that quantifies the accuracy of predicting the average cost associated with problem [symbol] ₂ can be defined. In particular, consider any d predicted sequences of anomalies [symbol] _{d}≙{ [symbol] ᵢ:i∈[d]}. The regret of these sequences with respect to the ground truth

$${\overline{𝒱}}_{d}^{*} {=}^{Δ} \{ {𝒱}_{d}^{*} : i ∈ [ d ] \}$$

can be defined as

$$regret ( {𝒱}_{d} ) {=}^{Δ} 1 - \frac{{\sum }_{i = 1}^{d} cost ( {𝒱}_{i} )}{{\sum }_{i = 1}^{d} cost ( {𝒱}_{i}^{*} )} . \qquad ( 10 )$$

Specifying the cause-effect relationship among a set of interacting entities in an interconnected network can be formalized via two components within prediction machine learning model 104: a directed graph that signifies the cause-effect directions among the entities and a structural causal model that quantifies the extent of each specific cause's effect. Interactions between the components of an interconnected system can be denoted by a directed graph [symbol] =([N],ε), where the set of nodes [N] represent the components of the interconnected system and the set of directed edges ε⊆[N]×[N] encode the cause-effect directions. Returning to the example of the transmission network, the set of nodes represents the transmission lines. Specifically, a directed edge from node i to node j≠i states that if the states of all nodes except i are fixed and the state of i is altered, this alteration induces a change in the state of node j. In cases when a change in a node induces a change in a group of nodes, the parents and children of node i, are denoted as pa(i)⊆N and ch(i)⊆N respectively. According to this model, when node i is anomalous, it can potentially impose anomalies only on the nodes in ch(i). Conversely, each node in i can become anomalous only if one of the nodes in pa(i) is anomalous. Node i is a direct cause of node j if j∈ch(i) and an indirect cause of node j if there is a path from i to j but j∉ch(i). If at least two nodes in the network can mutually impose an anomaly on one another, the graph [symbol] becomes cyclic and otherwise is free of cycles, alternatively referred to as acyclic. While a topological graph defines physical connections among components of an interconnected system, the graph [symbol] captures the latent relationships between components and characterizes how these relationships influence the propagation of anomalies in the interconnected network.

The directed graph [symbol] specifies the instantaneous cause-effect relationships between components of the interconnected network. To specify the extent of these relationships, prediction machine learning model 104 can comprise a framework for quantifying these cause-effect relationships, where the state of node i∈[N] at time t is determines by its parent's state, denoted as

$${S}_{pa ( i )} [ t ] {=}^{Δ} \{ {S}_{j} [ t ] : j ∈ pa ( i ) \} according to {S}_{i} [ t ] = {h}_{i} ( {S}_{pa ( i )} [ t ] ) + {ϵ}_{i} , \qquad ( 11 )$$

where hᵢ represents the function describing how the states of node i's parents influence node i and ∈ᵢ accounts for the unobserved random causes on node i. In some cases, the function hᵢ may involve a linear or non-linear transformation of the parent's state. Focusing on linear structural causal models, the cause-effect relationship between components states is defined as

$$S [ t ] {=}^{Δ} B \cdot S [ t ] + ϵ , \qquad ( 12 )$$

where B∈ [symbol] ^{N×N} is a latent causal interaction matrix. Specifically, Bᵢⱼ≠0 if an only if i∈ch(j) in [symbol] , and ∈∈ [symbol] ^{N} denotes the random vector of unobserved causes, such that each random variable ∈ᵢ is independent of the other.

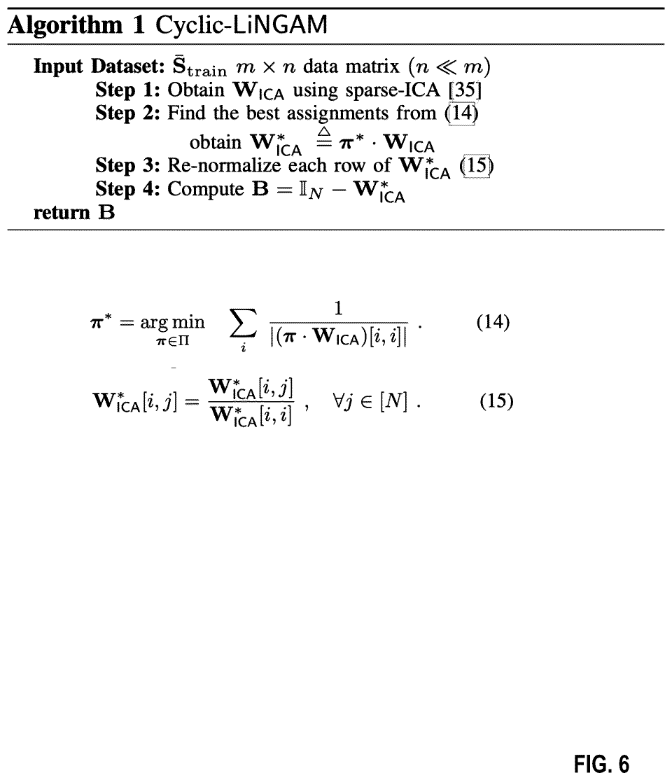

Accurate prediction of the latent anomaly states relies on both the causal graph [symbol] and the causal interaction matrix B, as they collectively govern the propagation of anomalies in the network. An effective approach to causal discovery in directed cyclic graphs is illustrated in algorithm 1 of FIG. 6, which infers the causal graph [symbol] and the interaction matrix B from observational multi-variate time series data. Accordingly, training component 110 can train prediction machine learning model 104 to learn B using algorithm 1. The historical dataset utilized for learning B is denoted as S̅ₜᵣₐᵢₙ. The creation of such training data is discussed in detail below.

The causal discovery objective is to learn matrix B, which governs the relationships among different entries of S[t] specified by equation (12). The first step is noise decomposition via independent component analysis. For this purpose, A≙ [symbol] _{N}−B is defined. When A is invertible, S̅ₜᵣₐᵢₙ can alternatively be represented as a liner combination of ∈,

$${\overline{S}}_{train} = {( {𝕀}_{N} - B )}^{- 1} \cdot ϵ = {A}^{- 1} \cdot ϵ . \qquad ( 13 )$$

Independent component analysis algorithms find an invertible linear transformation W_{ICA}∈ [symbol] ^{N×N} of the data S̅ₜᵣₐᵢₙ with the objective that renders the noise distribution e to be maximally non-Gaussian and independent. Following this objective, the obtained matrix W_{ICA} can be identified up to scaling and permutation of A⁻¹ as long as the observed data distribution Sₜᵣₐᵢₙ is a linear and invertible mixture of independent noise components ∈ᵢ. To eliminate relationships characterized by low strength within W_{ICA}, a sparse ICA algorithm can be utilized to estimate W_{ICA} from S̅ₜᵣₐᵢₙ, thereby rendering the latent cause-effect relationship encoded in B sparse. Since W_{ICA} is equivalent to A only up to a proper scaling and permutation, in the following steps proper permutation and scaling is applied to W_{ICA} to transform it to a high-fidelity estimate of A.

When [symbol] is acyclic, an optimal assignment W_{ICA} is unique. However, when [symbol] is cyclic, the optimal assignment may not be unique. Due to the permutation indeterminacy of ICA in step 1 above, the rows of W_{ICA} are in random order. To find the correct correspondence between the independent components ∈ᵢ and the data S̅ₜᵣₐᵢₙ, training component 110 can permute the rows of W_{ICA} to obtain the correct correspondence. Let π∈Π denote a row permutation matrix such that the new matrix π·W_{ICA} has the rows of W_{ICA} rearranged, where |Π|=N!. An assignment algorithm can be used to construct π* to identify the best choice

$${W}_{ICA}^{*} {=}^{Δ} {π}^{*} \cdot {W}_{ICA}$$

wherein

$${π}^{*} = {arg min}_{π ∈ Π} {\sum }_{i} \frac{1}{\vert ( π \cdot {W}_{ICA} ) [ i , j ] \vert} . \qquad ( 14 )$$

Scaling indeterminacy of ICA is solved by assuming all independent components ∈ᵢ to have unit variance and scaling

$${W}_{ICA}^{*}$$

appropriately. Contrary to this assumption, in algorithm 1, independent components ∈ᵢ can have arbitrary variance values, thereby retaining the variance of ∈ᵢ, the diagonal elements of

$${W}_{ICA}^{*} [ i , j ] = 1 , ∀ i ∈ [ N ] .$$

This necessitates to re-normalize the rows of

$${W}_{ICA}^{*}$$

so that all the diagonal elements equal 1, e.g.,

$${W}_{ICA}^{*} [ i , j ] = \frac{{W}_{ICA}^{*} [ i , j ]}{{W}_{ICA}^{*} [ i , j ]} , ∀ j ∈ [ N ] . \qquad ( 15 )$$

Finally, the set of causal interaction matrices B can be obtained as

$$B = {N}_{} - {W}_{ICA}^{*}$$

and training component 110 can train prediction learning model 104 to learn B using algorithm 1.

Learning a matrix B that can capture all the intricate cause-effect dependencies among anomalies in various lines critically depends on rich training data S̅ₜᵣₐᵢₙ that adequately captures various anomalous scenarios. To create a comprehensive dataset, training component 110 can monitor the variations in the anomaly index Sᵢ[t] in equation (2) for each line i∈[N]. To capture various anomalous scenarios in S̅ₜᵣₐᵢₙ, training component 110 can monitor these variations for an initiating anomaly in each component k∈[N]. Subsequently, for each anomalous component k∈[N] and loading condition l∈ [symbol] training component 110 can calculate power flow in component i∈[N] under anomalous condition

$${P}_{i}^{{l}_{k}} [ 1 ] and flows {P}_{i}^{l} [ 0 ]$$

under normal condition in order to compute the anomaly index

$${S}_{i}^{{l}_{k}}$$

for each component i via equation (2). This results in a total of | [symbol] |·L training data samples S^{l}^{ₖ} collectively denoted by

$${\overline{S}}_{train}^{k} {=}^{Δ} \{ {S}^{{l}_{k}} : l ∈ ℒ \} , \qquad ( 16 )$$

for each anomalous component k∈[N], rendering an extensive dataset

$${\overline{S}}_{train} {=}^{Δ} {⋃}_{k}^{N} {\overline{S}}_{train}^{k} .$$

Each sub-dataset

$${\overline{S}}_{train}^{k}$$

captures the extent to which an anomaly in a line k∈[N] influences the anomalous states of other lines. The data generating mechanism

$${\overline{S}}_{train}^{k}$$

is cycle because each stage in a cascade is a phase-space transition from one stable equilibrium to another, where the anomaly states

$${S}_{i}^{{l}_{k}} and {S}_{j}^{{l}_{k}} , ∀ i , j ∈ [ N ]$$

interact mutually and reach corresponding steady states.

Each occurrence of an anomaly alters the system dynamics, necessitating corresponding adjustments to the learned matrix B. Ideally, learning a causal graph based on empirical observations from each stage m of the cascade can be a solution. However, learning causal interaction matrices associated with each stage m∈[M] in a cascade requires scenario-based simulations that become combinatorically more complex as the system size N and the horizon M, increase. To address this issue, training component 110 can employ interventions that alter the learned matrix B at each stage of the cascade.

For this purpose, corresponding to a given ordered sequence of existing anomalous components [symbol] in the system, an updated graph [symbol] ( [symbol] ) can be defined that represents the latent causal structure that captures the cause-effect dynamics in the system that has undergone a sequence of anomalies in [symbol] . The corresponding matrix is denoted as B( [symbol] ).

Corresponding to each possible initiating anomalous component or line, one latent causal structure [symbol] ( [symbol] ) and the associated causal matrix B( [symbol] ) for [symbol] ={i} are defined as follows. When the initiating anomalous line or component is i∈[N] set [symbol] ={i} and prediction machine learning model 104 can learn the set of causal matrices [symbol] wherein

$$ℬ {=}^{Δ} \{ B ( 𝒰 ) : 𝒰 = \{ i \} , i ∈ [ N ] \} , \qquad ( 17 )$$

using the corresponding observational dataset

$${\overline{S}}_{train}^{i}$$

in equation (16) and using the procedure set forth in algorithm 1. Each causal matrix B( [symbol] )∈ [symbol] captures the extent to which an initiating anomalous line or component [symbol] influences the anomaly states of its children j∈ch( [symbol] ₘ).

Consider the stage m∈[M] of the cascade, up to which the ordered set of lines [symbol] ₘ≙ [symbol] [symbol] ₁, . . . , [symbol] ₘ [symbol] have become anomalous. Prediction machine learning model 104 can leverage the matrix B( [symbol] ₘ)∈ [symbol] learned from the initiating anomaly [symbol] ₘ and consider intervention mechanisms to find the updated B( [symbol] ₘ) as follows.

$${[ B ( {𝒩}_{m} ) ]}_{i , j} = \{ \begin{matrix}0 & i ∈ {𝒩}_{m - 1} \\ {[ B ( {𝒩}_{m} ) ]}_{i , j} & i ∉ {𝒩}_{m - 1}\end{matrix} . \qquad ( 18 )$$

At stage m, the lines included in the set [symbol] ₘ₋₁ are already anomalous and cannot be affected further by their parents. Based on this, the update rule in equation (18) is specified to ensure that the only causal relationships associated with the most recent anomaly [symbol] ₘ are considered.

Based on this learning and updating process, prediction machine learning model 104 is prepared to make real-time anomaly predictions about the interconnected system. In [symbol] ₁, the objective is real-time prediction of the next anomaly when a cascade has begun, e.g., in stage m of the cascade, predicting the transmission lines that will become anomalous at stage m+1. This prediction relies on the hidden dependencies among nodes extracted from the dynamic causal matrices B( [symbol] ₘ), which is found via a sequence of interventions according to equation (18).

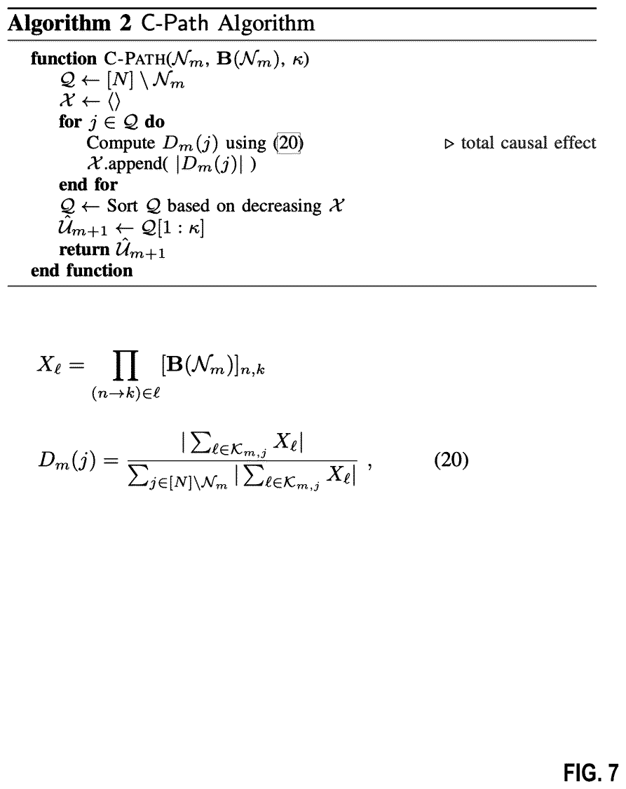

At stage m, given the most recent anomalous line [symbol] ₘ and given the causal matrix updated B( [symbol] ₘ), a set of components or lines causally influenced by [symbol] ₘ are denoted by [symbol] ₘ₊₁. The influence of anomalous [symbol] ₘ can propagate through the paths involving the descendants of [symbol] ₘ in graph [symbol] ( [symbol] ₘ). To obtain aggregate causal effects along all the direct paths from i∈ [symbol] ₘ to j∈[N]\ [symbol] ₘ prediction machine learning model 104 can leverage causal path analysis as discussed below. To produce a solution to [symbol] ₁, algorithm 2 of FIG. 7 is utilized. At stage m, the direct path from [symbol] ₘ to j∈[N]\ [symbol] ₘ is denoted by [symbol] ₘ [symbol] j. The set of all such direct paths in [symbol] (Nₘ) is denoted by [symbol] _{m,j}. The contribution of each path [symbol] ∈ [symbol] _{m,j} is specified by the product of the edge coefficients on this path, denoted by

$${X}_{ℓ} = {\prod }_{( n \to k ) ∈ ℓ} {[ B ( {𝒩}_{m} ) ]}_{n , k} . \qquad ( 19 )$$

By summarizing the contributions of all paths [symbol] ∈ [symbol] _{m,j}, and normalizing over all j∈[N]\ [symbol] ₘ the total influence is

$${D}_{m} ( j ) = \frac{\vert {\sum }_{ℓ ∈ {𝒦}_{m , j}} {X}_{ℓ} \vert}{{\sum }_{j ∈ [ N ] / {𝒩}_{m}} \vert {\sum }_{ℓ ∈ {𝒦}_{m , j}} {X}_{ℓ} \vert} , \qquad ( 20 )$$

which quantifies the cumulative effect of the anomaly state, S [symbol] _{ₘ}[m], on line/component j. The metric Dₘ(j) acts as a proxy for the probabilities [symbol] (j|B̅ₘ,S̅ₘ) in equation (7) extent to which an anomaly at [symbol] ₘ can be amplified as it propagates through the network. Finally, prediction machine learning model 104 selects [symbol] ₘ₊₁ as the set of lines with the top k associated terms in

$$\{ {D}_{m} ( j ) : j ∈ [ N ] / {𝒩}_{m} \} {\hat{𝒰}}_{m + 1} {=}^{Δ} {arg max}_{𝒰 ⊆ [ N ] \backslash 〈 {𝒰}_{1} , … , {𝒰}_{m} ; 〉 \vert 𝒰 \vert \leq k} {\sum }_{j ∈ 𝒰} {D}_{m} ( j ) . \qquad ( 21 )$$

The objective of problem [symbol] ₂ is to find the top d most costly sequences out of all possible cascades (e.g., the cascades most likely to cause widespread failures in the interconnected system). Similarly to solving [symbol] ₁, prediction machine learning model 104 can apply causal reasoning to identify these sequences. Specifically, algorithm 2 of FIG. 7 can be implemented recursively and used to generate a set of predicted sequences. This process has two stages that are now described in detail.

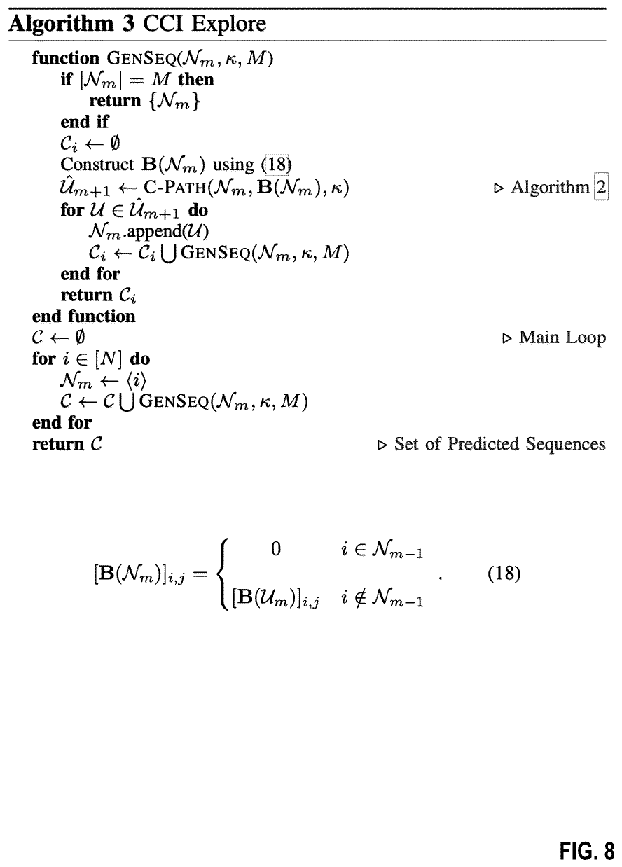

The first stage is exploration. For each initiating anomaly i∈[N] in stage m=1, the prediction machine learning model 104 starts by predicting the k most probable lines/components to be anomalous at m=2 using algorithm 2. This set is specified by [symbol] ₂. Considering one line/component can be anomalous at each stage of the cascade, for each line/component j∈ [symbol] ₂, prediction machine learning model 104 can further obtain the set of top k line/components that are most likely to be anomalous at m=3. This set in turn is denoted by [symbol] ₃. This recursive process extends to all stages m∈[M] to explore the sequences until prediction machine learning model 104 reaches the maximum depth M. This process obtains N×k^{M-1} sequences as the candidates for being a solution to [symbol] ₂. The recursive exploration steps are outlined in algorithm 3 of FIG. 8.

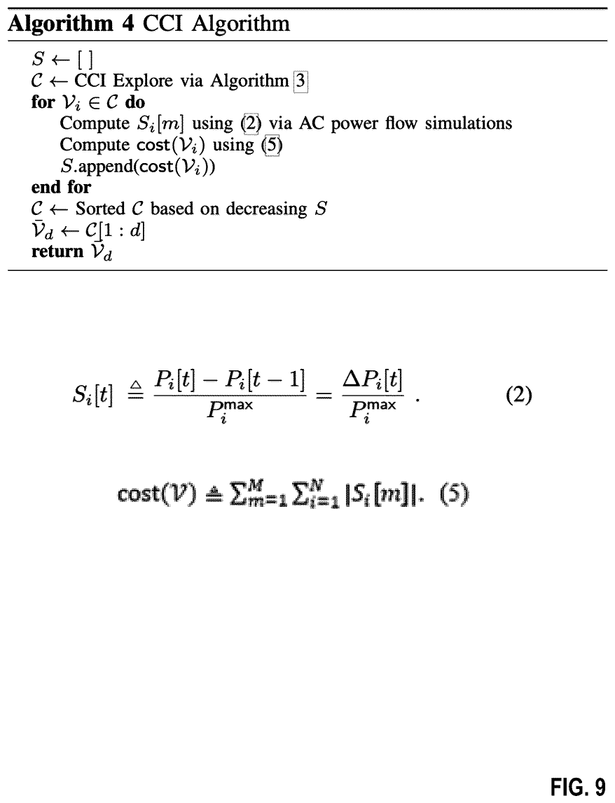

The second stage is critical cascade identification. Upon obtaining a set of candidates [symbol] , prediction machine learning model 104 can calculate the cost corresponding to each of the sequences specified by equation (5) and identify the top d most costly sequences denoted by [symbol] _{d}. The exploration stage significantly reduces the search space for such sequences. This takes what would otherwise be a very computationally intense search to one that is more practical to achieve. Moreover, utilizing algorithm 2 to obtain the sequences provides the critical transmission lines/components in each stage m, which helps prediction machine learning model 104 explore the local and non-local behavior of an anomaly sequence. Based on this, the steps for selecting the top d most costly sequences are summarized in Algorithm 4 of FIG. 9 and are specified to ensure efficient exploration in the causally guided search space.

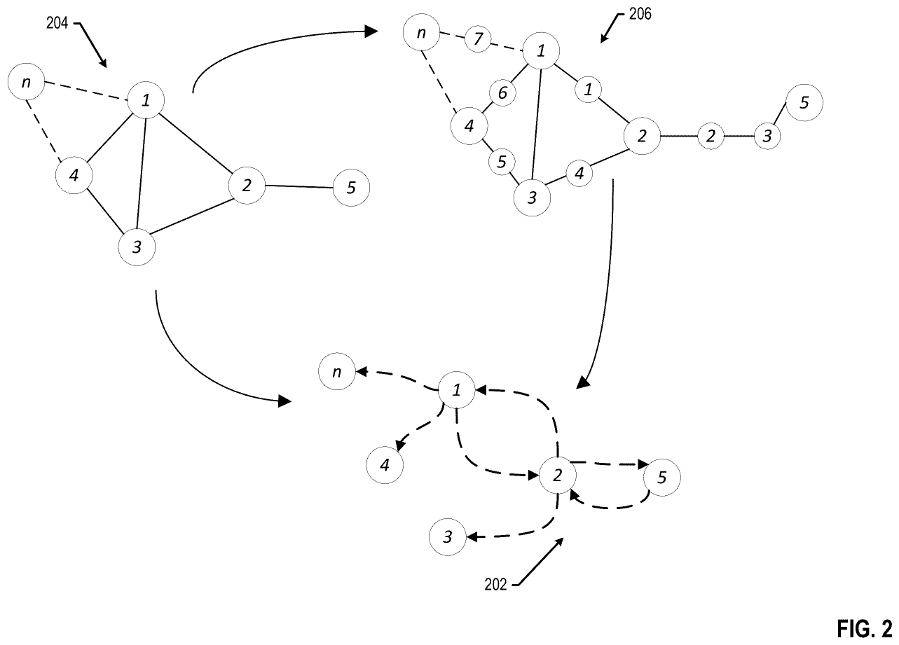

FIG. 2 illustrates an example of a causal structural graph 202 in accordance with one or more embodiments described herein.

As shown, causal structural graph 202 comprises nodes representing components within an interconnected system and directed edges between the nodes. The directed edges represent an interaction and the direction of the interaction between the nodes of the causal graph. For example, as node 1 has a directed edge leading to node 4, this illustrates that when node 1 is experiencing an anomalous state, the state of node 4 might change as a result. As shown, causal structural graph 202 can be generated through the use of both the latent state space 204 and the observational space 206.

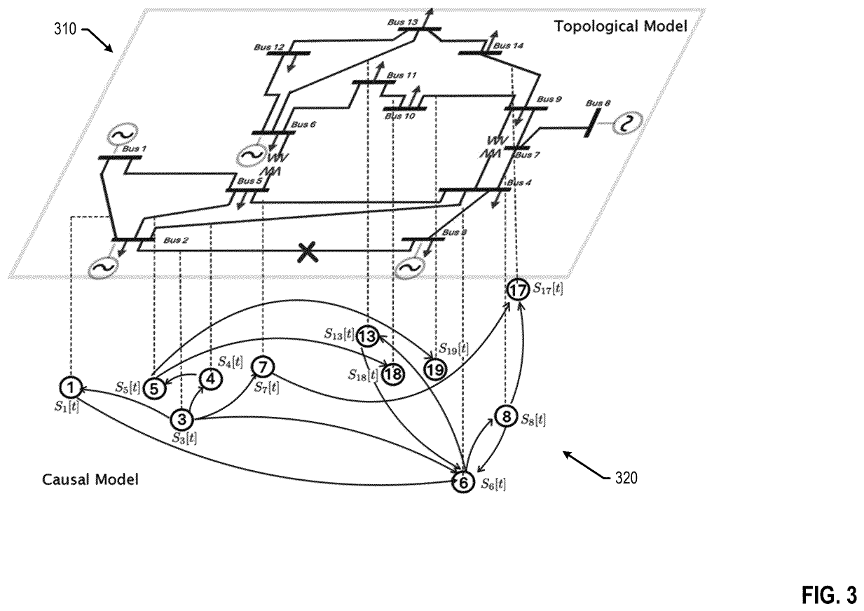

FIG. 3 illustrates a comparison of a topological model of an interconnected system and a causal graph of the interconnected system in accordance with one or more embodiments described herein.

As shown, topological model 310 shows the physical layout of a transmission network and the various physical connections between components and transmission lines of an interconnected system. As described in detail above, topological models fail to represent latent relationships accurately and efficiently throughout the system. In contrast, causal graph 320 captures line/components of topological model 310 as nodes and represents the latent interactions between nodes as directed edges. This captures how these interactions can facilitate the propagation of anomalies throughout the interconnected system. For example, causal graph 320 comprises various edges directly connected between nodes representing components that are not directly connected within the topological model. In this manner, causal graph 320 can more accurately capture latent or non-local relationships within the interconnected system.

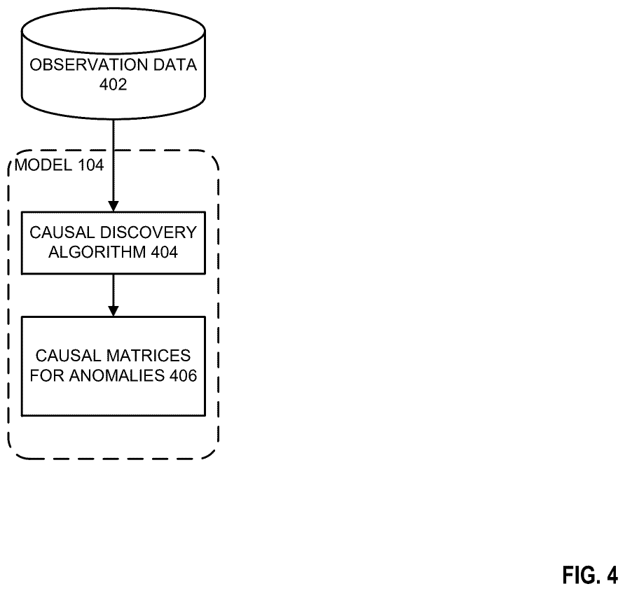

FIG. 4 illustrates a flow diagram 400 of an example, non-limiting, training method for prediction machine learning model 104 in accordance with one or more embodiments described herein. For example, as described in relation to FIG. 1, training component 110 can collect observation data 402 from an interconnected system. This observation data 402 is then fed to prediction machine learning model 104 which uses a causal discovery algorithm (e.g., algorithm 1) to learn a set of causal matrices for anomalies within the interconnected system. The set of matrices comprises a matrix for each component within the interconnected system which describes the extent to which initiating an anomaly on that component influences the states of child components of the component in question. In this manner, prediction machine learning model 104 can learn how anomalies are likely to propagate through the system.

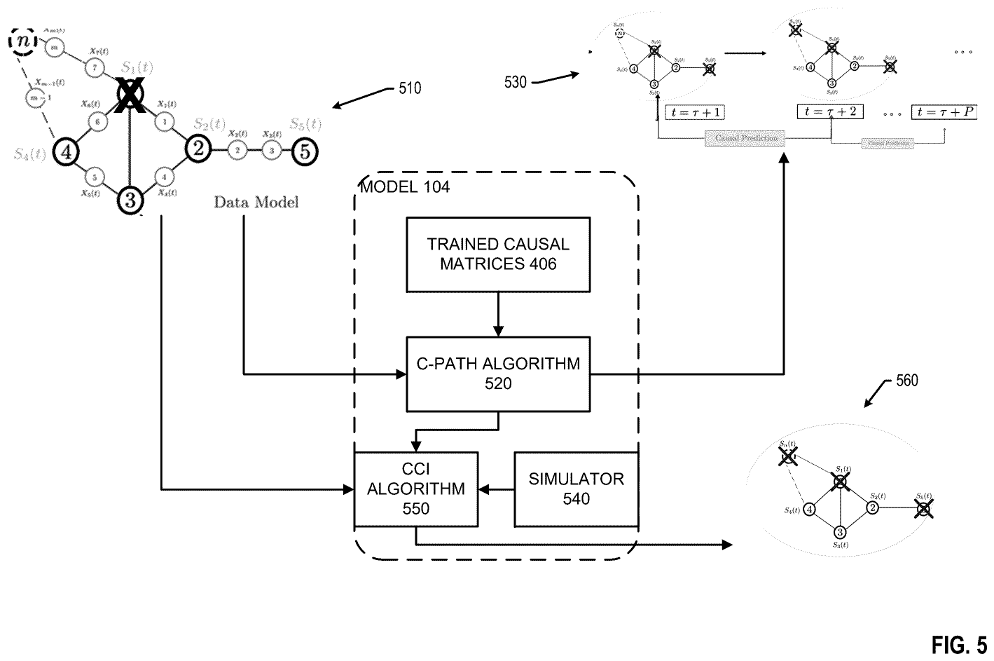

FIG. 5 illustrates a flow diagram of real-time cascade propagation prediction in accordance with one or more embodiments described herein.

First, prediction machine learning model 104 receives real-time data 510 indicating that an anomaly has occurred in the interconnected system. Prediction machine learning model 104 can utilize this data 510, along with the causal matrices 406 trained in FIG. 4, as inputs to a causal path algorithm 520 (e.g., algorithm 2 of FIG. 7) to generate a list 530 of all possible cascades of anomalies through the interconnected system. This list can both be output to an entity managing the interconnected system to be utilized in remedial measures as well as an input, along with simulator 540 to CCI algorithm 550 (e.g., algorithms 3 and 4 of FIGS. 8-9) generate a predicted critical anomaly cascade path 560 that illustrates the possible cascade path that could cause the highest amount of anomaly propagation of failures throughout the interconnected system.

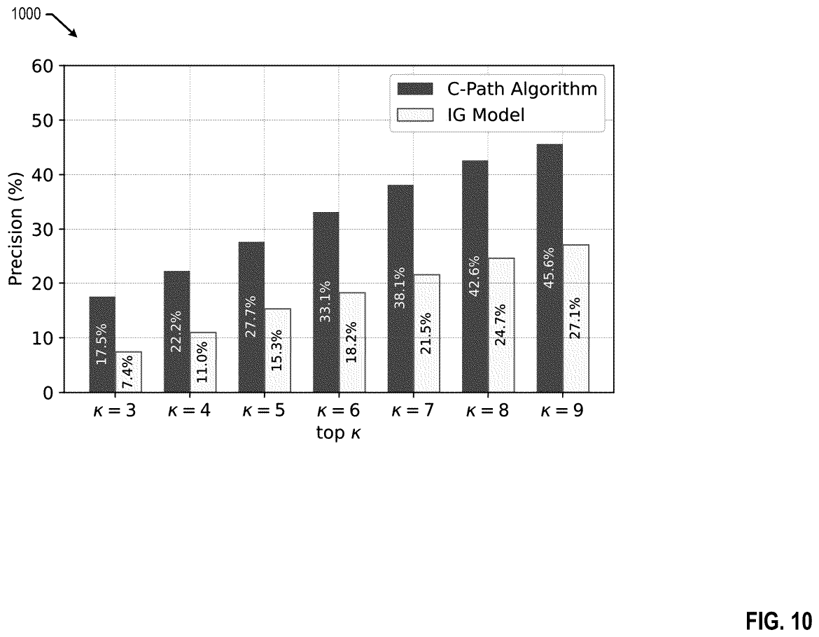

FIG. 10 illustrates a graph 1000 comparing the accuracy of a prediction machine learning model (e.g., C-path algorithm) as described herein to an influence graph (e.g., IG) approach in accordance with one or more embodiments described herein.

The y-axis of graph 1000 illustrates the accuracy of the comparative approaches of predicting propagation of anomalies and the x-axis represents the top k number of propagation predictions the approaches were asked to generate. As shown, the approach described herein shows marked improvements in precision of predictions across all k levels in comparison to an existing IG approach, illustrating a proportional precision increase as the value of k increases.

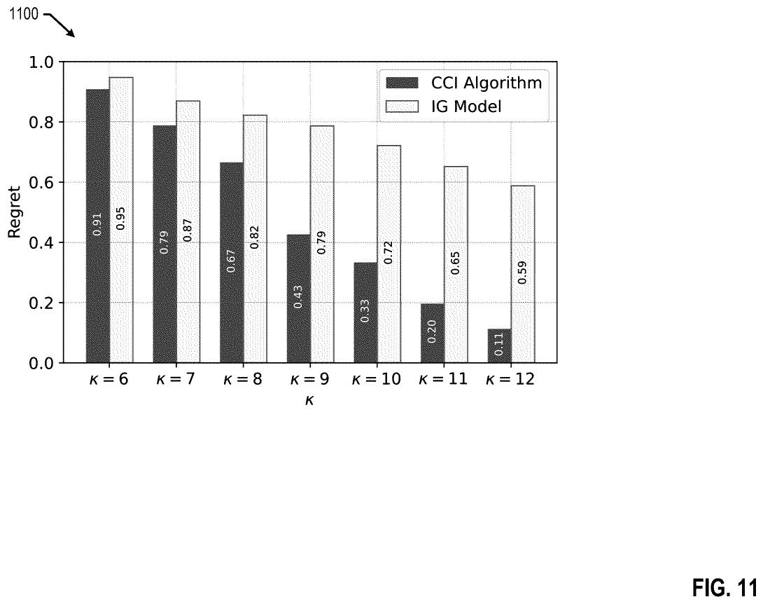

FIG. 11 illustrates a graph 1100 comparing the performance of a prediction machine learning model (e.g., C-path algorithm) as described herein to an influence graph (e.g., IG) approach at predicting high-cost anomaly propagations.

The y-axis of graph 1100 illustrates a regret metric of the comparative approaches, wherein a lower regret value indicates that the approach more accurately identified potential high-cost cascades of anomalies. As described above in relation to FIG. 1, the cost of an anomaly is determined by how many other components the anomaly could propagate in and how much stress such a propagation is likely to cause to the system. The x-axis represents the top k number of propagation predictions the approaches were asked to generate. As shown, the approach described herein produces a lower regret score at all k values in relation to an existing IG approach, but specifically has much better performance at higher k values. This illustrates how the approach described herein is able to identify low-probability but high cost anomaly cascades better than existing approaches.

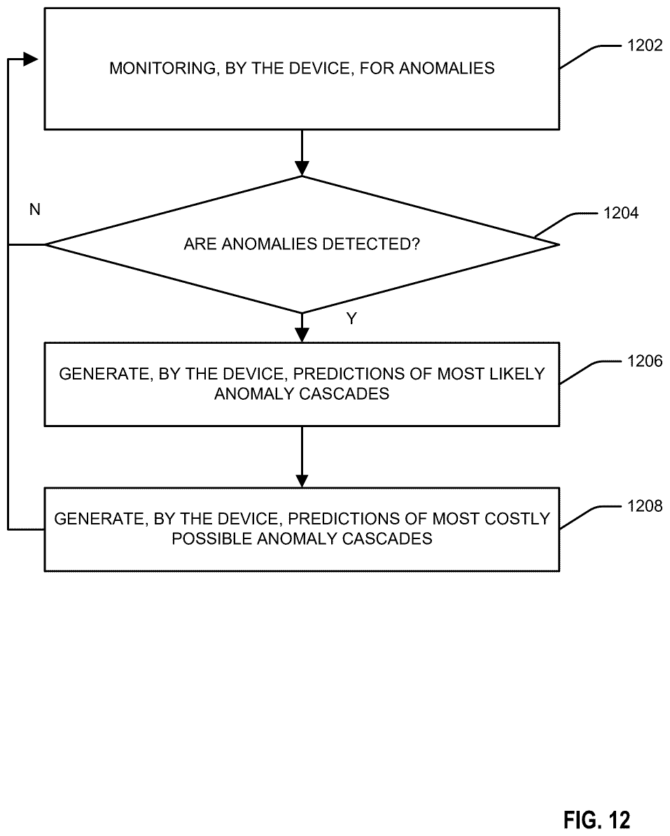

FIG. 12 illustrates a flow diagram of an example, non-limiting, computer implemented method 1200 that facilitates predictions of propagations of anomalies within interconnected systems in accordance with one or more embodiments described herein. Repetitive description of like elements employed in other embodiments described herein is omitted for sake of brevity.

At 1202, method 1200 can comprise monitoring, by a device (e.g., system 102) operatively coupled to a processor (e.g., processor 106), for anomalies within the interconnected system. For example, one or more sensors can report anomalous behavior in one or more components of the interconnected system to system 102.

At 1204, method 1204 can comprise determining, by the device (e.g., system 102 and/or prediction machine learning model 104), if one or more anomalies are detected in one or more components of the interconnected system In response to a NO determination, method 1200 can return to step 1202 and continue monitoring. In response to a YES determination, method 1200 can proceed to step 1206.

At 1206, method 1200 can comprise generating, by the device (e.g., system 102 and/or prediction machine learning model 104), predictions of the most likely cascades of anomalies to occur based on the anomaly that has occurred and the component experiencing the anomaly. For example, as described above in relation to FIGS. 1 and 5, prediction machine learning model 104 can utilize a set of learned causal matrices as well as a causal path algorithm (e.g., algorithm 2 of FIG. 7) to generate a list of k most likely propagation paths of the anomaly, wherein k is defined by an entity such as a user.

At 1208, method 1200 can comprise generating, by the device (e.g., system 102 and/or prediction machine learning model 104) predictions of the most costly possible cascades of anomalies to occur based on the anomaly that has occurred and the component experiencing the anomaly. For example, as described above in relation to FIGS. 1 and 5, prediction machine learning model 104 can utilize a list of all possible cascades of anomalies and identify cascade paths that may be unlikely to occur, but could cause the most stress to the interconnected system if they were to occur.

A practical application of system 102 is that it can generate more accurate predictions of both how anomalies are likely to cascade or propagate through an interconnected system and predictions of possible cascades that could cause the most stress or disruption to the interconnected system. For example, through the generation of causal graphs, the systems and methods described herein can accurately capture latent or non-neighbor interactions within an interconnected system that are not accurately captured in other approaches such as those focusing on topology of the interconnected system. Furthermore, these predictions can be generated in real-time, allowing for better management and anomaly mitigation by entities managing or operating the interconnected system.

It is to be appreciated that system 102 can utilize various combination of electrical components, mechanical components, and circuitry that cannot be replicated in the mind of a human or performed by a human as the various operations that can be executed by system 102 and/or components thereof as described herein are operations that are greater than the capability of a human mind. For instance, the amount of data processed, the speed of processing such data, or the types of data processed by system 102 over a certain period of time can be greater, faster, or different than the amount, speed, or data type that can be processed by a human mind over the same period of time. According to several embodiments, system 102 can also be fully operational towards performing one or more other functions (e.g., fully powered on, fully executed, and/or another function) while also performing the various operations described herein. It should be appreciated that such simultaneous multi-operational execution is beyond the capability of a human mind. It should be appreciated that system 102 can include information that is impossible to obtain manually by an entity, such as a human user. For example, the type, amount, and/or variety of information included in system 102 can be more complex than information obtained manually by an entity, such as a human user.

According to some embodiments prediction machine learning model 104 can employ automated learning and reasoning procedures (e.g., the use of explicitly and/or implicitly trained statistical classifiers) in connection with performing inference and/or probabilistic determinations and/or statistical-based determinations in accordance with one or more aspects described herein.

For example, prediction machine learning model 104 can employ principles of probabilistic and decision theoretic inference to determine one or more responses based on information retained in a knowledge source database. In various embodiments, prediction machine learning model 104 can employ a knowledge source database comprising artificial intelligence use case categories and appropriate risk mitigation actions. Additionally, or alternatively, prediction machine learning model 104 can rely on predictive models constructed using machine learning and/or automated learning procedures. Logic-centric inference can also be employed separately or in conjunction with probabilistic methods. For example, decision tree learning can be utilized to map observations about data retained in a knowledge source database to derive a conclusion as to a response to a question.

As used herein, the term “inference” refers generally to the process of reasoning about or inferring states of the system, a component, a module, the environment, and/or assessments from one or more observations captured through events, reports, data, and/or through other forms of communication. Inference can be employed to identify a specific context or action, or can generate a probability distribution over states, for example. The inference can be probabilistic. For example, computation of a probability distribution over states of interest can be based on a consideration of data and/or events. The inference can also refer to techniques employed for composing higher-level events from one or more events and/or data. Such inference can result in the construction of new events and/or actions from one or more observed events and/or stored event data, whether or not the events are correlated in close temporal proximity, and whether the events and/or data come from one or several events and/or data sources. Various classification schemes and/or systems (e.g., support vector machines, neural networks, logic-centric production systems, Bayesian belief networks, fuzzy logic, data fusion engines, and so on) can be employed in connection with performing automatic and/or inferred action in connection with the disclosed aspects. Furthermore, the inference processes can be based on stochastic or deterministic methods, such as random sampling, Monte Carlo Tree Search, and so on.

The various aspects can employ various artificial intelligence-based schemes for carrying out various aspects thereof. For example, a process for determining text segmentation boundaries, text capitalization and punctuation, without interaction from the target entity, which can be enabled through an automatic classifier system and process.

A classifier is a function that maps an input attribute vector, x=(x1, x2, x3, x4, xn), to a confidence that the input belongs to a class. In other words, f(x)=confidence (class). Such classification can employ a probabilistic and/or statistical-based analysis (e.g., factoring into the analysis utilities and costs) to prognose or infer an action that should be employed to make a determination. The determination can include, how an anomaly will cascade through an interconnect network.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that can be similar, but not necessarily identical to training data. Other directed and undirected model classification approaches (e.g., naïve Bayes, Bayesian networks, decision trees, neural networks, fuzzy logic models, and probabilistic classification models) providing different patterns of independence can be employed. Classification as used herein, can be inclusive of statistical regression that is utilized to develop models of priority.

One or more aspects can employ classifiers that are explicitly trained (e.g., through a generic training data) as well as classifiers that are implicitly trained (e.g., by observing and recording target entity behavior, by receiving extrinsic information, and so on). For example, SVM's can be configured through a learning phase or a training phase within a classifier constructor and feature selection module. Thus, a classifier(s) can be used to automatically learn and perform a number of functions, including but not limited to classification of cascades of anomalies through an interconnected system. Furthermore, one or more aspects can employ machine learning models that are trained utilizing reinforcement learning. For example, penalty/reward scores can be assigned for various outputs generated by prediction machine learning model 104 based on defined entity preferences. Accordingly, prediction machine learning model 104 can learn via selecting options with lower penalties and/or higher rewards in order to reduce an overall penalty score and/or increase an overall reward score.

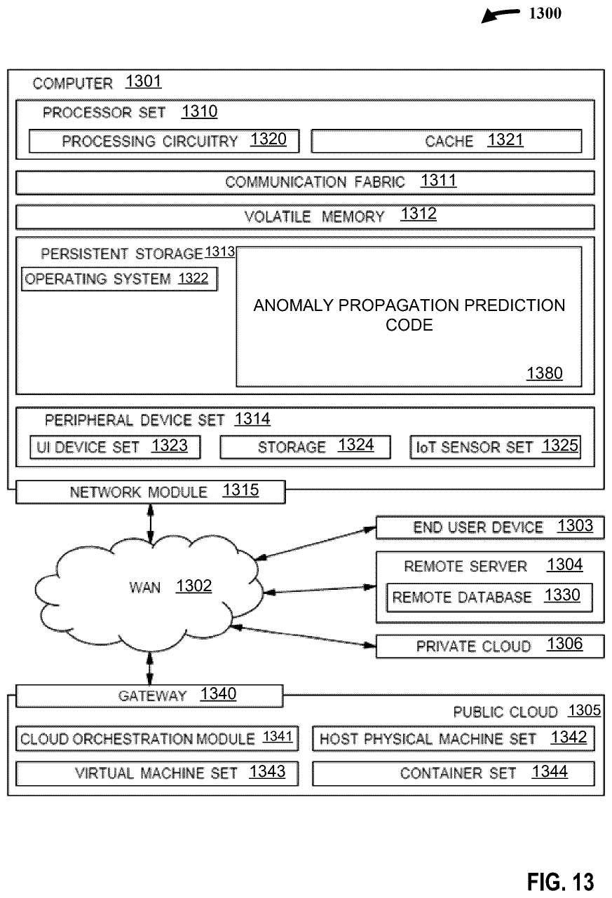

FIG. 13 and the following discussion are intended to provide a brief, general description of a suitable computing environment 1300 in which one or more embodiments described herein at FIGS. 1-11 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1300 contains an example of an environment for the execution of at least some of the computer code involved in performing the inventive methods, such as translation of an original source code based on a configuration of a target system by the use case classification code 1380. In addition to block 1380, computing environment 1300 includes, for example, computer 1301, wide area network (WAN) 1302, end user device (EUD) 1303, remote server 1304, public cloud 1305, and private cloud 1306. In this embodiment, computer 1301 includes processor set 1310 (including processing circuitry 1320 and cache 1321), communication fabric 1311, volatile memory 1312, persistent storage 1313 (including operating system 1322 and block 1380, as identified above), peripheral device set 1314 (including user interface (UI), device set 1323, storage 1324, and Internet of Things (IoT) sensor set 1325), and network module 1315. Remote server 1304 includes remote database 1330. Public cloud 1305 includes gateway 1340, cloud orchestration module 1341, host physical machine set 1342, virtual machine set 1343, and container set 1344.

COMPUTER 1301 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1330. As is well understood in the art of computer technology, and depending upon the technology, performance of a computer-implemented method can be distributed among multiple computers and/or between multiple locations. On the other hand, in this presentation of computing environment 1300, detailed discussion is focused on a single computer, specifically computer 1301, to keep the presentation as simple as possible. Computer 1301 can be located in a cloud, even though it is not shown in a cloud in FIG. 13. On the other hand, computer 1301 is not required to be in a cloud except to any extent as can be affirmatively indicated.

PROCESSOR SET fabric includes one, or more, computer processors of any type now known or to be developed in the future. Processing circuitry 1320 can be distributed over multiple packages, for example, multiple, coordinated integrated circuit chips. Processing circuitry 1320 can implement multiple processor threads and/or multiple processor cores. Cache 1321 is memory that is located in the processor chip package(s) and is typically used for data or code that should be available for rapid access by the threads or cores running on processor set 1310. Cache memories are typically organized into multiple levels depending upon relative proximity to the processing circuitry. Alternatively, some, or all, of the cache for the processor set can be located “off chip.” In some computing environments, processor set 1310 can be designed for working with qubits and performing quantum computing.

Computer readable program instructions are typically loaded onto computer 1301 to cause a series of operational steps to be performed by processor set 1310 of computer 1301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1321 and the other storage media discussed below. The program instructions, and associated data, are accessed by processor set 1310 to control and direct performance of the inventive methods. In computing environment 1300, at least some of the instructions for performing the inventive methods can be stored in block 1380 in persistent storage 1313.

COMMUNICATION FABRIC 1311 is the signal conduction path that allows the various components of computer 1301 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 1312 is any type of volatile memory now known or to be developed in the future. Examples include dynamic type random access memory (RAM) or static type RAM. Typically, the volatile memory is characterized by random access, but this is not required unless affirmatively indicated. In computer 1301, the volatile memory 1312 is located in a single package and is internal to computer 1301, but, alternatively or additionally, the volatile memory can be distributed over multiple packages and/or located externally with respect to computer 1301.

PERSISTENT STORAGE 1313 is any form of non-volatile storage for computers that is now known or to be developed in the future. The non-volatility of this storage means that the stored data is maintained regardless of whether power is being supplied to computer 1301 and/or directly to persistent storage 1313. Persistent storage 1313 can be a read only memory (ROM), but typically at least a portion of the persistent storage allows writing of data, deletion of data and re-writing of data. Some familiar forms of persistent storage include magnetic disks and solid-state storage devices. Operating system 1322 can take several forms, such as various known proprietary operating systems or open-source Portable Operating System Interface type operating systems that employ a kernel. The code included in block 1380 typically includes at least some of the computer code involved in performing the inventive methods.

PERIPHERAL DEVICE SET 1314 includes the set of peripheral devices of computer 1301. Data communication connections between the peripheral devices and the other components of computer 1301 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1323 can include components such as a display screen, speaker, microphone, wearable devices (such as goggles and smart watches), keyboard, mouse, printer, touchpad, game controllers, and haptic devices. Storage 1324 is external storage, such as an external hard drive, or insertable storage, such as an SD card. Storage 1324 can be persistent and/or volatile. In some embodiments, storage 1324 can take the form of a quantum computing storage device for storing data in the form of qubits. In embodiments where computer 1301 is required to have a large amount of storage (for example, where computer 1301 locally stores and manages a large database) then this storage can be provided by peripheral storage devices designed for storing large amounts of data, such as a storage area network (SAN) that is shared by multiple, geographically distributed computers. IoT sensor set 1325 is made up of sensors that can be used in Internet of Things applications. For example, one sensor can be a thermometer and another sensor can be a motion detector.

NETWORK MODULE 1315 is the collection of computer software, hardware, and firmware that allows computer 1301 to communicate with other computers through WAN 1302. Network module 1315 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 1315 are performed on the same physical hardware device. In other embodiments (for example, embodiments that utilize software-defined networking (SDN)), the control functions and the forwarding functions of network module 1315 are performed on physically separate devices, such that the control functions manage several different network hardware devices. Computer readable program instructions for performing the inventive methods can typically be downloaded to computer 1301 from an external computer or external storage device through a network adapter card or network interface included in network module 1315.

WAN 1302 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1303 is any computer system that is used and controlled by an end user (for example, a customer of an enterprise that operates computer 1301) and can take any of the forms discussed above in connection with computer 1301. EUD 1303 typically receives helpful and useful data from the operations of computer 1301. For example, in a hypothetical case where computer 1301 is designed to provide a recommendation to an end user, this recommendation would typically be communicated from network module 1315 of computer 1301 through WAN 1302 to EUD 1303. In this way, EUD 1303 can display, or otherwise present, the recommendation to an end user. In some embodiments, EUD 1303 can be a client device, such as thin client, heavy client, mainframe computer and/or desktop computer.

REMOTE SERVER 1304 is any computer system that serves at least some data and/or functionality to computer 1301. Remote server 1304 can be controlled and used by the same entity that operates computer 1301. Remote server 1304 represents the machine(s) that collect and store helpful and useful data for use by other computers, such as computer 1301. For example, in a hypothetical case where computer 1301 is designed and programmed to provide a recommendation based on historical data, then this historical data can be provided to computer 1301 from remote database 1330 of remote server 1304.

PUBLIC CLOUD 1305 is any computer system available for use by multiple entities that provides on-demand availability of computer system resources and/or other computer capabilities, especially data storage (cloud storage) and computing power, without direct active management by the scale. The direct and active management of the computing resources of public cloud 1305 is performed by the computer hardware and/or software of cloud orchestration module 1341. The computing resources provided by public cloud 1305 are typically implemented by virtual computing environments that run on various computers making up the computers of host physical machine set 1342, which is the universe of physical computers in and/or available to public cloud 1305. The virtual computing environments (VCEs) typically take the form of virtual machines from virtual machine set 1343 and/or containers from container set 1344. It is understood that these VCEs can be stored as images and can be transferred among and between the various physical machine hosts, either as images or after instantiation of the VCE. Cloud orchestration module 1341 manages the transfer and storage of images, deploys new instantiations of VCEs and manages active instantiations of VCE deployments. Gateway 1340 is the collection of computer software, hardware and firmware allowing public cloud 1305 to communicate through WAN 1302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1306 is similar to public cloud 1305, except that the computing resources are only available for use by a single enterprise. While private cloud 1306 is depicted as being in communication with WAN 1302, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1135 and private cloud 1136 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system comprising: a memory that stores computer executable components; a processor that executes the computer executable components stored in the memory, wherein the computer executable components comprise:
a prediction machine learning model that predicts propagation of anomaly cascades through an interconnected system, wherein the predicting comprises:
extracting a data matrix from a causal graph, wherein the causal graph represents the interconnected system; and
generating a data set comprising at least one of historic data or a simulation data set of the interconnected system.

2. The system of claim 1, wherein the predicting further comprises generating a causal structural model based on the generated data set.

3. The system of claim 2, wherein the predicting further comprises simulating a cascading of anomalies based on the causal structural model.

4. The system of claim 3, wherein the predicting further comprises determining non-local behavior of the interconnected system, based on the cascading of anomalies.

5. The system of claim 1, wherein the computer executable components further comprise a training component that trains the prediction machine learning model on non-local interactions of the interconnected system through a latent causal graph.

6. The system of claim 5, wherein the latent causal graph comprises multi-variate time series data from the interconnected system.

7. A computer-implemented method comprising:
predicting, by a device operatively coupled to a processor, propagation of anomaly cascades through an interconnected system, wherein the predicting comprises:
extracting, by the device, a data matrix from a causal graph, wherein the causal graph represents the interconnected system; and
generating, by the device, a data set comprising at least one of historic data or a simulation data set of the interconnected system.

8. The computer-implemented method of claim 7, wherein the predicting further comprises generating a causal structural model based on the generated data set.

9. The computer implemented method of claim 8, wherein the predicting further comprises simulating a cascading of anomalies based on the causal structural model.

10. The computer-implemented method of claim 9, wherein the predicting further comprises determining non-local behavior of the interconnected system, based on the cascading of anomalies.

11. The computer-implemented method of claim 7, wherein the interconnected system comprises at least one of a power grid, a communication network, a traffic network, or a supply chain.

12. The computer-implemented method of claim 7, further comprising, learning, by the device, non-local interactions of the interconnected system through a latent causal graph.

13. The computer-implemented method of claim 12, wherein the latent causal graph comprises multi-variate time series data from the interconnected system.

14. A computer program product comprising a non-transitory computer-readable memory having program instructions embodied therewith, the program instructions executable by the processor to cause the processor to:
predict, by the processor, propagation of anomaly cascades through an interconnected system, wherein the predicting comprises:
extracting, by the processor, a data matrix from a causal graph, wherein the causal graph represents the interconnected system; and
generating, by the processor, a data set comprising at least one of historic data or a simulation data set of the interconnected system.

15. The computer program product of claim 14, wherein the predicting further comprises generating a causal structural model based on the generated data set.

16. The computer program product of claim 15, wherein the predicting further comprises simulating a cascading of anomalies based on the causal structural model.

17. The computer program product of claim 16, wherein the predicting further comprises determining non-local behavior of the interconnected system, based on the cascading of anomalies.

18. The computer program product of claim 14, wherein the interconnected system comprises at least one of a power grid, a communication network, a traffic network, or a supply chain.

19. The computer program product of claim 14, wherein the program instructions are further executable by the processor to cause the processor to learn, by the processor, non-local interactions of the interconnected system through a latent causal graph.

20. The computer program product of claim 19, wherein the latent causal graph comprises multi-variate time series data from the interconnected system.
